(19) United States
(12) Patent Application Publication
(10) Pub. No.: US 2004/0199378 A1
(43) Pub. Date: Oct. 7, 2004

(54) Translation system, translation method, and program and recording medium for use in realizing them

(75) Inventors: Harumi Itoh, Tokyo-to (JP); Tomohiro Miyahira, Yamato-shi (JP); Yoshiroh Kamiyama, Tokyo-to (JP)

Correspondence Address: IBM CORPORATION, 3039 CORNWALLIS RD., DEPT. T81 / B503, PO BOX 12195, REASEARCH TRIANGLE PARK, NC, 27709, US

(73) Assignee: International Business Machines Corporation, Armonk, NY (US)

(21) Appl. No.: 10/819,033

(22) Filed: Apr. 6, 2004

(30) Foreign Application Priority Data
Apr. 7, 2003 (JP) 2003-102664

(51) Int. Cl. G06F 17/28

(52) U.S. Cl. 704/5

(57) ABSTRACT

The present invention increases translation accuracy by translating a document in a translation mode, depending on a display format for the document. A translation system for translating a document comprises a specified portion extraction unit for extracting specified portions of the document which are specified to be displayed in predetermined display formats and a translation processing unit for translating contents of the specified portions in a noun phrase translation mode in which the contents are translated as noun phrases more preferentially in comparison with the other portions of the document.

### FIELD OF THE INVENTION

The present invention relates to a translation system, a translation method, and a program and a recording medium for use in realizing them. In particular, the present invention relates to a translation system, a translation method, and a program and a recording medium for use in realizing them, which can allow for switching between translation processes, depending on a display format specified in a document to be translated.

### BACKGROUND ART

Conventionally, a prior technology as described in Published Unexamined Patent Application No. 2002-259374 (Patent Publication 1) has been disclosed to improve translation accuracy of a translation system for translating a document. The prior technology in Patent Publication 1 collects English articles written in a source language (English) and articles written in a target language (Japanese). When it desires to translate an English article into Japanese, it detects a Japanese article corresponding to the English article concerned. Then, it extracts the headline and text portions from the English and Japanese articles, respectively, and embeds the headline portion extracted from the Japanese article in a translation of the English article as a translated headline portion.

### PROBLEMS TO BE SOLVED BY THE INVENTION

With the prior technology in Patent Publication 1 above, if the corresponding Japanese article has been collected, the source headline portion which may be difficult to be subjected to machine translation can be replaced with the headline portion of the collected Japanese article. However, the above-mentioned process is valid only if the corresponding Japanese article exists, and in addition, it has not taken account of improvement in translation accuracy for the text portion.

Therefore, it is an object of the present invention to provide a translation system, a translation method, and a program and a recording medium for use in realizing them, which can solve the above-mentioned problems. The present object can be attained by means of any combination of features according to the independent claims in claims. The dependent claims described above define further advantageous embodiments of the present invention.

### SUMMARY OF THE INVENTION

Therefore, according to a first embodiment of the present invention, there are provided a translation system for translating a document, which comprises a specified portion extraction unit for extracting specified portions of the document which are specified to be displayed in a predetermined display format; and a translation processing unit for translating contents of the specified portions in a noun phrase translation mode in which the contents are translated as noun phrases more preferentially in comparison with the other portions of the document, and in addition, a translation method, a program, and a recording medium for use in realizing the system.

The summary of the invention described above does not enumerate all features necessary for the present invention and thus, any subcombination of these features may also constitute the present invention.

### BRIEF DESCRIPTION OF THE DRAWINGS

FIG. 1 shows the configuration of a translation system 10 according to an embodiment of the present invention;

FIG. 2 shows a flow of process performed by the translation system 10 according to the embodiment of the present invention;

FIG. 3 shows an example of a document to be translated by the translation system 10 according to the embodiment of the present invention, wherein FIG. 3(a) shows an example of a document described in a list display format with unordered beginning-of-line characters, and FIG. 3(b) shows an example of a document described in a list display format with ordered beginning-of-line characters;

FIG. 4 shows another example of a document to be translated by the translation system 10 according to the embodiment of the present invention;

FIG. 5 shows still another example of a document to be translated by the translation system 10 according to the embodiment of the present invention, wherein FIG. 5(a) shows an example of a document described in a tabular display format, and FIG. 5(b) shows an example of a document which includes control information used to specify that the document be displayed in a tabular display format;

FIG. 6 shows still another example of a document to be translated by the translation system 10 according to the embodiment of the present invention, wherein FIG. 6(a) shows an example of the document displayed by means of a list box, FIG. 6(b) shows an example of the document displayed by means of a drop-down list, FIG. 6(c) shows an example of the document displayed by means of radio buttons, FIG. 6(d) shows an example of the document displayed by means of check boxes, and FIG. 6(e) shows an example of the document displayed by means of a multi-item enumeration;

FIG. 7 shows a flow of process performed at S250 by the translation system 10 according to the embodiment of the present invention;

FIG. 8 shows still another example of a document to be translated by the translation system 10 according to the embodiment of the present invention;

FIG. 9 shows an example of feature selection performed by the translation system 10 according to the embodiment of the present invention, wherein FIG. 9(a) shows an example of selecting the feature of language and FIG. 9(b) shows an example of selecting the feature of citizen;

FIG. 10 shows still another example of a document to be translated by the translation system 10 according to the embodiment of the present invention, wherein FIG. 10(a) shows that the document includes a common portion as the subject common to the items in the list shown therein, and FIG. 10(b) shows that the document includes a common portion having the subject and predicator common to the items in the list shown therein;

FIG. 11 shows an example of output translation provided by the translation processing unit 120 according to the embodiment of the present invention, wherein FIG. 11(a) shows an output translation when sentences are to be translated preferentially, and FIG. 11(b) shows an output translation when noun phrases are to be translated preferentially; and

FIG. 12 shows an example of the hardware configuration of a computer 1000 according to the embodiment of the present invention.

### PREFERRED EMBODIMENT OF THE INVENTION

Now, the present invention will be described below with reference to specific embodiments but the present invention should not be limited to those embodiments described later and all combinations of the features described with reference to the embodiments may not be necessarily essential to the present invention.

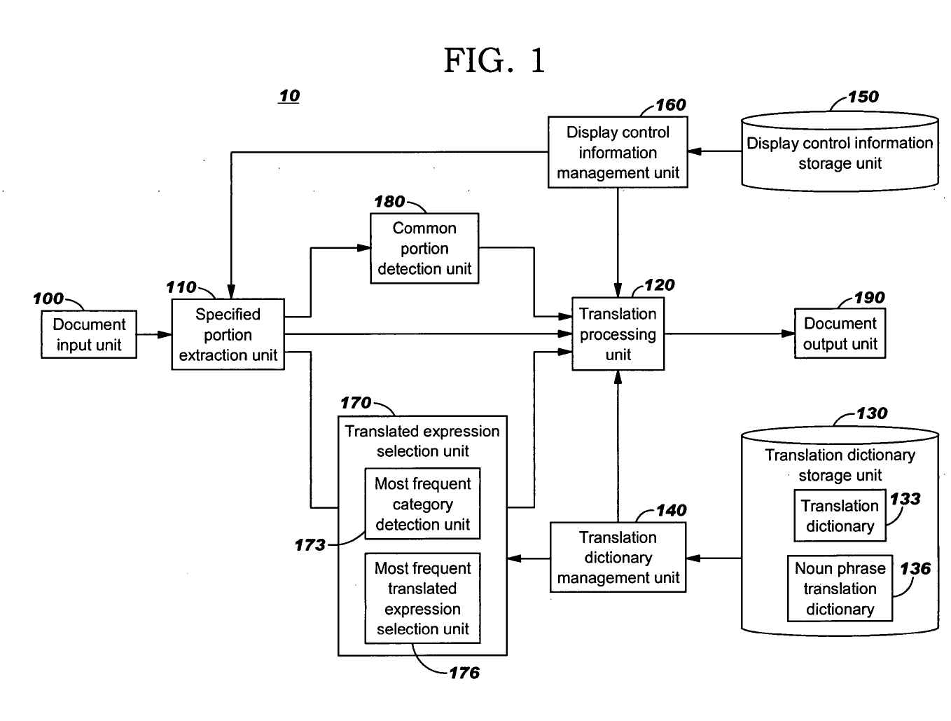

FIG. 1 shows the configuration of a translation system 10 according to the embodiment. The translation system 10 according to the embodiment is a computer system implemented in a user's PC, PDA, or mobile telephone or a server system to which a user gets access through a network, and translates portions of a source document which are specified to be displayed in predetermined display formats, for example, in a list or table, as noun phrases more preferentially in comparison with the other portions. If a subject is followed by a plurality of verb phrases, for example, in a list, the translation system 10 adds one or more subjects appropriate to these verb phrases before translating the document. This process can allow the translation system 10 to provide more appropriate translation with improved translation accuracy.

The translation system 10 comprises a document input unit 100, a specified portion extraction unit 110, a translation processing unit 120, a translation dictionary storage unit 130, a translation dictionary management unit 140, a display control information storage unit 150, a display control information management unit 160, a translated expression selection unit 170, a common portion detection unit 180, and a document output unit 190.

The document input unit 100 accepts a source document (a document to be translated) as input. The specified portion extraction unit 110 extracts portions of the accepted source document which is specified to be displayed in predetermined display formats, for example, in a list or table. The translation processing unit 120 acquires the source document through the specified portion extraction unit 110 and then translates it in translation modes corresponding to the specified portions.

The translation dictionary storage unit 130 stores translation dictionaries such as a translation dictionary 133 and a noun phrase translation dictionary 136 which are used by the translation processing unit 120 for translation. The translation dictionary 133 stored in the translation dictionary storage unit 130 may include a translated expression dictionary which records translated expressions and a grammar dictionary which records grammatical rules used for translation. The noun phrase translation dictionary 136 is a translation dictionary used by the translation processing unit 120 in a noun phrase translation mode in which expressions are to be translated as noun phrases more preferentially. The translation dictionary management unit 140 manages the translation dictionaries stored in the translation dictionary storage unit 130 and supplies some of the contents of the translation dictionaries at the request of the translation processing unit 120 or the translated expression selection unit 170.

The display control information storage unit 150 stores display format specification information which is contained in the document and used to specify the specified portion. The display control information management unit 160 manages the display format specification information stored in the display control information storage unit 150 and supplies the display format specification information to the specified portion extraction unit 110 or the translation processing unit 120 at the request thereof. The display format specification information may be beginning-of-line characters (for example, “•”, “+”, “−”, “*”, “>”, “1.”) to be used, for example, in a list display format or control information (for example, HTML tags) to be used for specifying a display method for the specified portion of the document.

The translated expression selection unit 170 selects, for each of a plurality of items in a list or a plurality of elements in a table for the specified portion, an appropriate translated expression among a plurality of translated expressions corresponding to the item or element concerned.

More specifically, an expression contained in the item or element has one or more translated expressions belonging to one or more categories (features) of, for example, human, language, place, and animal. For example, a noun “Japanese” has two translated expressions, one of which is “Nihonjin” belonging to the feature of person or citizen and the other of which is “Nihongo” belonging to the feature of language. The translated expression selection unit 170 selects a desired category among those to which one or more translated expressions corresponding to each of the plurality of items or elements are belonging to select an appropriate translated expression.

The translated expression selection unit 170 has a most frequent category detection unit 173 and a most frequent translated expression selection unit 176. The most frequent category detection unit 173 detects the most frequent category to which the most of the translated expressions corresponding to each of the plurality of items or elements are belonging. The most frequent translated expression selection unit 176 selects, for each of the plurality of items or elements, a translated expression belonging to the most frequent category detected by the most frequent category detection unit 173.

The common portion detection unit 180 detects whether or not each of the plurality of items in a list for the specified portion forms a sentence in combination with a common portion described earlier than the specified portion. More specifically, for example, the common portion detection unit 180 detects whether each of the plurality of items forms a sentence which includes an expression described earlier than the specified portion as a common subject (hereinafter referred to as “no-subject sentence”). When it is detected that each of the plurality of items forms a sentence in combination with a common portion, the translation processing unit 120 translates the item concerned as a sentence combined with the common portion. More specifically, for example, when the common portion detection unit 180 detects that the specified portion is a no-subject sentence, the translation processing unit 120 translates the item concerned as a sentence which includes an expression described earlier than the specified portion as its subject.

The document output unit 190 provides an output document translated by the translation processing unit 120.

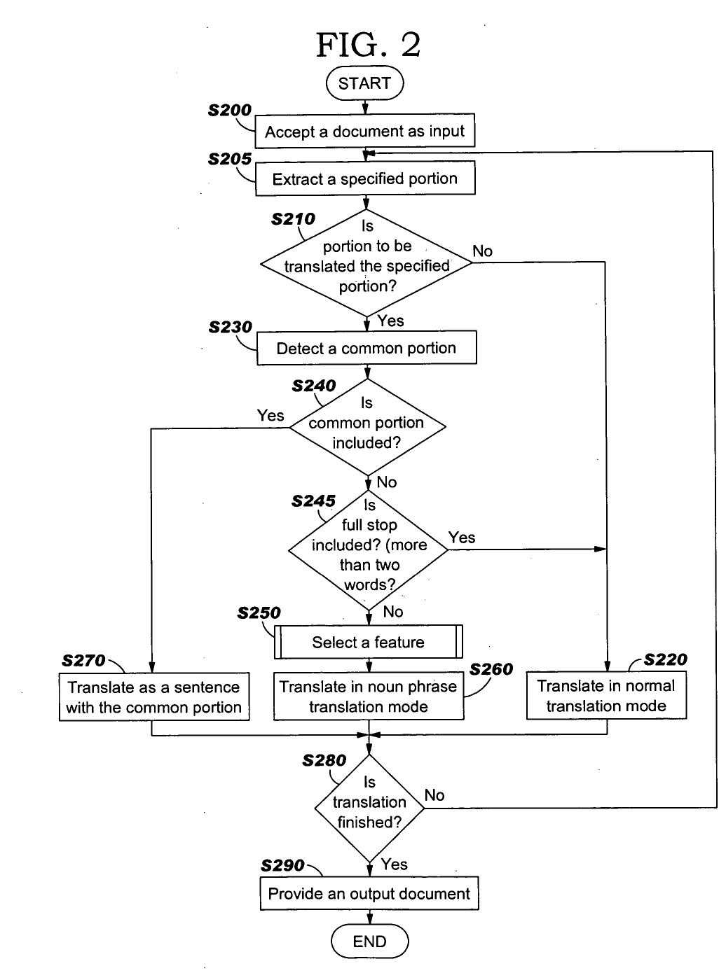

FIG. 2 shows a flow of process performed by the translation system 10 according to the embodiment.

First, the document input unit 100 accepts a source document as input (S200). If the translation system 10 is implemented on a user's information processing unit, the document input unit 100 may accept, as the source document, a document entered or specified by the user. On the contrary, if the translation system 10 is implemented on a server system, the document input unit 100 may accept, as the source document, a document entered or specified at the user's terminal through a network.

Next, the specified portion extraction unit 110 extracts a portion of the source document which is specified to be displayed in a predetermined display format (S205). More specifically, the specified portion extraction unit 110 acquires display format specification information stored in the display control information storage unit 150 through the display control information management unit 160 and extracts a portion which is specified by the display format specification information to be displayed in the predetermined display format when the display format specification information is detected in the document. For the specified portion extraction unit 110 according to the embodiment, predetermined display formats include a list display format to display at least a portion of the document in a list of a plurality of items and a tabular display format to display at least a portion of the document in a table with a plurality of elements (cell elements).

If a portion to be translated is not equal to the specified portion (S210), the translation processing unit 120 makes reference to the translation dictionary 133 in the translation dictionary storage unit 130 to translate the portion to be translated in normal translation mode (S220). On the contrary, if the portion to be translated is equal to the specified portion (S210), the specified portion extraction unit 110 progresses the process to S230.

Next, the common portion detection unit 180 detects whether each of the plurality of items in a list for the portion specified to be displayed in a list display format forms a sentence in combination with a common portion described earlier than the specified portion in the document (S230). For example, the common portion detection unit 180 detects whether each of the plurality of items is a no-subject sentence which assumes the common portion described earlier than the specified portion in the document as its subject in common with the other items. In addition, the common portion detection unit 180 may detect whether each of the plurality of items forms a sentence in combination with the common portion described earlier than the specified portion in the document by assuming that common portion as its subject and verb in common with the other items when the item concerned is an object, or may detect another set of parts of speech which forms a sentence as a combination of the common portion and the item concerned.

Next, if it is detected that each of the plurality of items forms a sentence in combination with the common portion (S240), the translation processing unit 120 translates each of the plurality of items as a sentence combined with the common portion and provides an output translation of the item concerned with the common portion excluded therefrom (S270). For example, if it is detected that each of the plurality of items is a no-subject sentence which assumes an expression as its subject in common with the other items, the translation processing unit 120 translates each of the plurality of items as a sentence which assumes the expression as its subject and provides an output translation of the item concerned with the subject excluded therefrom.

On the contrary, if it is not detected that the specified portion forms a sentence in combination with the common portion (S240), the translation processing unit 120 detects whether each item in a list or each element in a table for the specified portion has a full stop (S245). If the item or element has a full stop, it is quite likely to be a sentence with a noun and a verb and thus, the translation processing unit 120 uses the translation dictionary 133 in the translation dictionary storage unit 130 to translate the item or element in normal translation mode (S220).

If the item or element does not have any full stop at S245, it is quite likely to be a noun phrase and a plurality of items in the list or a plurality of elements in the table for the specified portion may also correspond to translated expressions of an identical feature. Therefore, the translated expression selection unit 170 selects, for each of the plurality of items in the list or each of the plurality of elements in the table for the specified portion, a translated expression of an appropriate feature among a plurality of translated expressions corresponding to the item or element concerned (S250). Then, the translation processing unit 120 translates the contents of the specified portion in a noun phrase translation mode, based on the translated expression selected at S250 (S260). A noun phrase translation mode is a translation mode in which, for example, the specified portion of the source document is translated as noun phrases more preferentially in comparison with the other portions of the document and the noun phrase translation dictionary 136 prepared for a noun phrase translation mode may be used.

The translation system 10 repeats the process steps S205 to S270 described above until the translation is finished (S280). When the translation is finished, the document output unit 190 provides an output translation of the target document. If the translation system 10 is implemented on a server system, the translated document may be provided to the user terminal through a network.

Alternatively, the translation processing unit 120 may detect, at S245, whether each item in the list or each element in the table for the specified portion includes words more than predetermined by a user or a manufacturer of the translating system 10, and more specifically, the translation processing unit 120 may detect whether the item or element concerned includes words more than predetermined, for example, more than two words. If the item or element concerned includes more-than-predetermined words, it is quite likely to be a sentence with a noun and a verb and thus, the translation processing unit 120 uses the translation dictionary 133 in the translation dictionary storage unit 130 to translate the item or element in normal translation mode at S220. On the contrary, if the item or element concerned includes no-more-than-predetermined words at S245, it is quite likely to be a noun phrase. Then, the translated expression selection unit 170 performs the processes of S250 and S260 to translate the item or element including no-more-than-predetermined words in a noun phrase translation mode.

The translation system 10 described above can select between normal translation mode and a noun phrase translation mode, based on a display format specified in the source document. This can allow the translation system 10 to appropriately translate, in a noun phrase translation mode, list or table portions from the document which is to be translated as noun phrases.

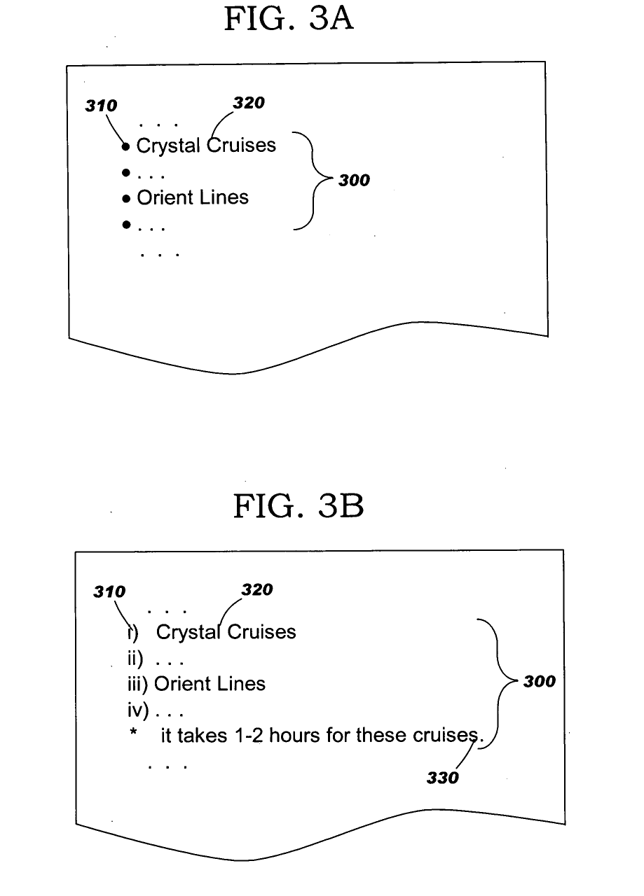

FIG. 3 shows an example of a document to be translated by the translation system 10 according to the embodiment.

FIG. 3(a) shows an example of a document described in a list display format with unordered beginning-of-line characters. The document in FIG. 3(a) includes a list 300 which consists of a plurality of beginning-of-line characters 310, each being displayed at the beginning of each line in the document, and a plurality of items 320, each corresponding to each of the plurality of beginning-of-line characters 310.

If the specified portion extraction unit 110 detects a beginning-of-line character 310 in the document at S205 in FIG. 2, it extracts an item 320 which is the contents of a line corresponding to the detected beginning-of-line character 310, as a specified portion. Alternatively, if the specified portion extraction unit 110 detects a plurality of beginning-of-line characters 310 and a plurality of items 320 corresponding to the plurality of beginning-of-line characters 310 in the document, it may extract a list 300 which includes the plurality of beginning-of-line characters 310 and the plurality of items 320, as a specified portion. The beginning-of-line character(s) 310 may be stored in the display control information storage unit 150 as display format specification information to be used for specifying a specified portion.

Then, the translation processing unit 120 translates the item(s) 320 specified to be displayed in a list in a noun phrase translation mode at S260 in FIG. 2.

FIG. 3(b) shows an example of a document described in a list display format with ordered beginning-of-line characters. The document-in FIG. 3(b) includes a list 300 which consists of a plurality of beginning-of-line characters 310 to be displayed, and a plurality of items 320, each corresponding to each of the plurality of beginning-of-line characters 310.

As with FIG. 3(a), if the specified portion extraction unit 110 detects a beginning-of-line character 310 in the document at S205 in FIG. 2, it extracts an item 320 which is the contents of a line corresponding to the detected beginning-of-line character 310, as a specified portion. Alternatively, if the specified portion extraction unit 110 detects a plurality of beginning-of-line characters 310 and a plurality of items 320 corresponding to the plurality of beginning-of-line characters 310 in the document, it may extract a list 300 which includes the plurality of beginning-of-line characters 310 and the plurality of items 320, as a specified portion.

Then, the translation processing unit 120 translates the item(s) 320 specified to be displayed in a list in a noun phrase translation mode at S260 in FIG. 2. The translation processing unit 120 may translate items with no full stop (for example, “•” in English and “∘” in Japanese) among the plurality of items specified by the display format specification information, that is, the beginning-of-line characters 310 to be displayed in a list, in a noun phrase translation mode in which they are translated as noun phrases more preferentially in comparison with the other items with full stops. In addition, the translation processing unit 120 may translate items with no-more-than-predetermined words among the plurality of items in a noun phrase translation mode in which they are translated as noun phrases more preferentially in comparison with the other items with more-than-predetermined words.

For example, as shown in FIG. 3(b), the translation processing unit 120 may translate items with no full stop 330 such as “Crystal Cruises” and “Orient Lines” as noun phrases more preferentially in comparison with another item with a full stop 330 such as “It takes 1-2 hours for these cruises.”

For the above description, the translation system 10 may use a character put at the beginning of each item listed in a list such as, for example, “●”, “+”, “−”, “*”, and “>” as the beginning-of-line character 310. In addition, the translation system 10 may use a character string put at the beginning of each item listed in a list or a character string for ordering items in the list such as, for example, “**”, “1., 2., 3. , . . . ”, “i), ii), iii), . . . ”, “\mathring{1+EE, 2+EE, 3}, . . . ”, and “a>, b>, c>, . . . ” as the beginning-of-line character 310. Moreover, the translation system 10 may use control code put at the beginning of each item listed in a list such as, for example, tab or indent code as the beginning-of-line character 310.

As a result of the processes described above, the translation processing unit 120 translates the portions specified to be displayed in a list in a noun phrase translation mode. This can allow the translation processing unit 120 to translate the item “Crystal Cruises” into, for example, a Japanese expression “Kurisutaru●kuruzu” as a noun phrase more preferentially, while it may translate the item into, for example, another Japanese expression by mistake “Suisho wa kokai suru” in normal translation mode. Thus, the translation system 10 can provide improved translation accuracy for the items listed in a list.

In addition, the translation processing unit 120 can translate an item with both a full stop 330 and more-than-predetermined words, for example, more-than-two words such as “It takes 1-2 hours for these cruises.” in normal translation mode, resulting in an improved translation accuracy for the item described as a sentence with a noun and a verb among these items.

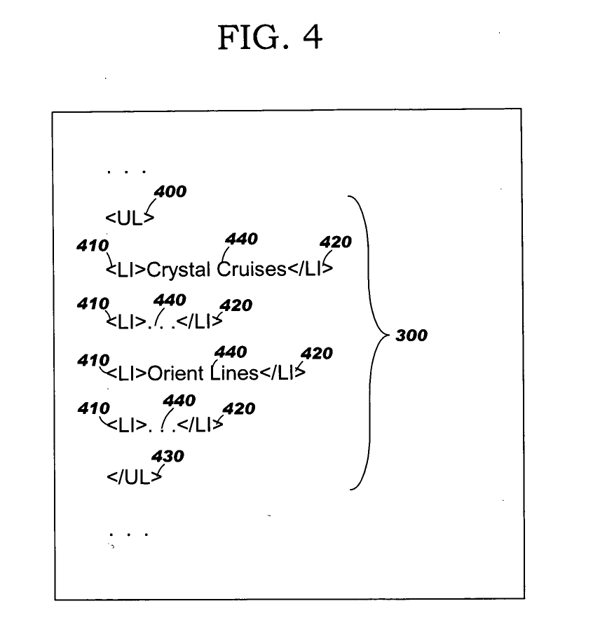

FIG. 4 shows another example of a document to be translated by the translation system 10 according to the embodiment. The document in this example is written, for example, in HTML and includes display format specification information which is control information used to specify a display method for the document and invisible to the user such as beginning-of-list specification information 400, beginning-of-item specification information 410, end-of-item specification information 420, and end-of-list specification information 430, and items 440 which are the contents to be displayed based on the display method specified by the beginning-of-list specification information 400 and the end-of-list specification information 430.

The beginning-of-list specification information 400 and the end-of-list specification information 430 are display format specification information used to specify that one or more items 400, which are at least part of contents information in the document, be displayed in a list of one or more items. More specifically, the beginning-of-list specification information 400 indicates the beginning point of the list put in the document and the end-of-list specification information 430 indicates the end point of the list. The list specified by the beginning-of-list specification information 400 and the end-of-list specification information 430 may be, for example, an unordered list described with a set of “<UL>” and “</UL>”, an ordered list described with a set of “<OL>” and “</OL>”, or a defined list described with a set of “<DL>” and “</DL>” in HTML.

The beginning-of-item specification information 410 and the end-of-item specification information 420 are item specification information used to specify each of a plurality of items to be displayed in a list. More specifically, the beginning-of-item specification information 410 indicates the beginning point of an item in the document and the end-of-item specification information 420 indicates the end point of the item. The item specified by the beginning-of-item specification information 410 and the end-of-item specification information 420 may be, for example, an item described with a set of “<LI>” and “</LI>”, an item described with a set of “<DT>” and “</DT>” and used to specify an expression to be defined in a defined list, or an item described with a set of “<DD>” and “</DD>” and used to describe the definition of an expression in the defined list in HTML. In addition, an item specified by the beginning-of-item specification information 410 with any description of the end-of-item specification information 420 omitted may be, for example, an item described with “<LI>”, an item described with “<DT>”, or an item described with “<DD>” in HTML.

The translation processing unit 120 translates each of a plurality of items which are contained in a portion specified by the beginning-of-list specification information 400 and the end-of-list specification information 430 to be displayed in a list, in a noun phrase translation mode at S260 in FIG. 2. Alternatively, the translation processing unit 120 may translate each of a plurality of items which are contained in a portion specified by the beginning-of-list specification information 400 and the end-of-list specification information 430 to be displayed in a list and which are also specified by the beginning-of-list specification information 410 and the end-of-item specification information 420, in a noun phrase translation mode.

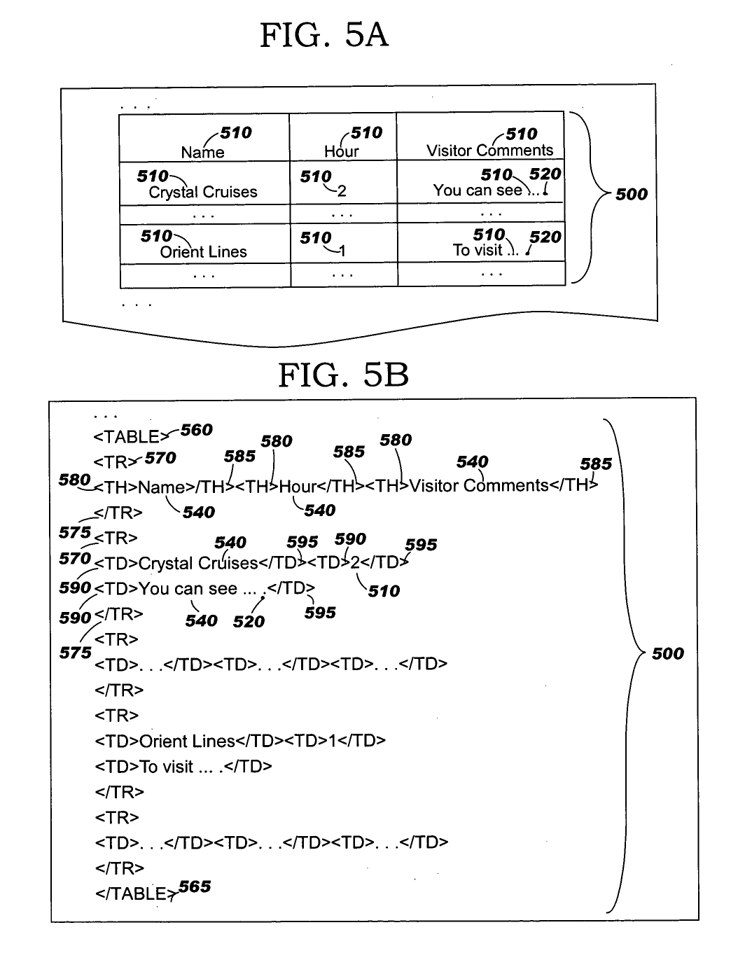

FIG. 5 shows still another example of a document to be translated by the translation system 10 according to the embodiment.

FIG. 5(a) shows an example of a document in a tabular display format. The document in FIG. 5(a) includes a table 500 written with an element 510 in each cell.

The specified portion extraction unit 110 extracts the table 500 as a portion of a source document which is specified to be displayed in a tabular display format at S205 in FIG. 2. Alternatively, the specified portion extraction unit 110 may extract each of a plurality of elements 510 as a specified portion.

Then, the translation processing unit 120 translates the plurality of elements 510 in the table 500 specified to be displayed in a table in a noun phrase translation mode at S260 in FIG. 2.

FIG. 5(b) shows an example of a document which includes control information used to specify that the document be displayed in a tabular display format. The document in FIG. 5(b) is written, for example, in HTML and includes display format specification information which is control information used to specify a display method for the document and invisible to the user such as beginning-of-table specification information 560, end-of-table specification information 565, beginning-of-line specification information 570, end-of-line specification information 575, beginning-of-header-element specification information 580, end-of-header-element specification information 585, beginning-of-data-element specification information 590, end-of-data-element specification information 595, and elements 540 which are the contents to be displayed based on the display method specified by the beginning-of-table specification information 560 and the end-of-table specification information 565.

The beginning-of-table specification information 560 and the end-of-table specification information 565 are display format specification information used to specify that elements 540, which are at least part of contents information in the document, be displayed in a table with a plurality of elements. More specifically, in the embodiment, the beginning-of-table specification information 560 indicates the beginning point of the table described in the document and the end-of-table specification information 565 indicates the end point of the table. The table specified by the beginning-of-table specification information 560 and the end-of-table specification information 565 may be described with, for example, a set of “<TABLE>” and “</TABLE>” in HTML.

The beginning-of-line specification information 570 and the end-of-line specification information 575 are display format specification information used to specify a set of elements to be displayed in each line among the plurality of elements to be display in a table.

The beginning-of-header-element specification information 580, the end-of-header-element specification information 585, the beginning-of-data-element specification information 590, and the end-of-data-element specification information 595 are element specification information used to specify each of the plurality of elements to be displayed in a table. More specifically, the beginning-of-header-element specification information 580 and the beginning-of-data-element specification information 590 indicate the beginning points of elements of the table in the document, respectively, and the end-of-header-element specification information 585 and the end-of-data-element specification information 595 indicate the end points of the elements, respectively. The element specified by the beginning-of-header-element specification information 580 and the end-of-header-element specification information 585 is, for example, an element written with a set of “<TH>” and “</TH>” in HTML to be a header element in the table. The element specified by the beginning-of-data-element specification information 590 and the end-of-data-element specification information 595 is, for example, an element written with a set of “<TD>” and “</TD>” in HTML to be a data element in the table. In addition, an element specified by the beginning-of-header-element specification information 580 or the beginning-of-data-element specification information 590 with any description of the end-of-header-element specification information 585 or the end-of-data-element specification information 595 omitted may be, for example, an element written with “<TH>” or an element described with “<TD>” in HTML.

The translation processing unit 120 translates each of a plurality of elements which are contained in a portion specified by the beginning-of-table specification information 560 and the end-of-table specification information 565 or by the beginning-of-line specification information 570 and the end-of-line specification information 575 to be displayed in a table, in a noun phrase translation mode at S260 in FIG. 2. Alternatively, the translation processing unit 120 may translate each of a plurality of elements which are contained in a portion specified by the beginning-of-table specification information 560 and the end-of-table specification information 565 to be displayed in a table and which are also specified by the beginning-of-header-element specification information 580 and the end-of-header-element specification information 585 or by the beginning-of-data-element specification information 590 and the end-of-data-element specification information 595, in a noun phrase translation mode.

In addition, the translation processing unit 120 may translate elements 510 with no full stop 520 among the plurality of elements in a noun phrase translation mode in which they are translated as noun phrases more preferentially in comparison with the other elements 510 with full stops 520 at S260 in FIG. 2. Alternatively, the translation processing unit 120 may translate elements 510 with no-more-than-predetermined words among the plurality of elements in a noun phrase translation mode in which they are translated as noun phrases more preferentially in comparison with the other elements 510 with more-than-predetermined words at S260 in FIG. 2.

As a result of the processes described above, the translation processing unit 120 translates the portions specified to be displayed in a table in a noun phrase translation mode. This can allow the translation processing unit 120 to translate the element “Visitor-Comments” into, for example, a Japanese expression “Homonsha komento” as a noun phrase more preferentially, while it may translate the item into, for example, another Japanese expression by mistake “Homonsha wa komento suru” in normal translation mode. Thus, the translation system 10 can provide improved translation accuracy for the elements listed in a table.

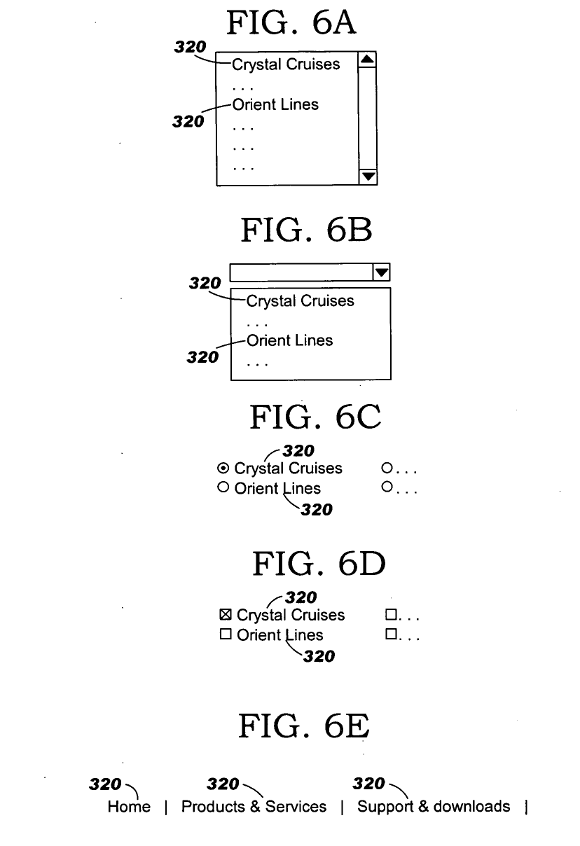

FIG. 6 shows still another example of a document to be translated by the translation system 10 according to the embodiment. FIGS. 6(a) to 6(e) show examples of the document displayed by means of a list box, a drop-down list, radio buttons, check boxes, and a plurality of listed items, respectively.

The specified portion extraction unit 110 may extract, as a specified portion to be displayed in a list, a list box (FIG. 6(a)), a drop-down list (FIG. 6(b)), descriptions associated with radio buttons (FIG. 6(c)), descriptions associated with check boxes (FIG. 6(d)), and a plurality of listed items (FIG. 6(e)) in a source document.

Then, the translated expression selection unit 170, the common portion detection unit 180, and the translation processing unit 120 may perform the processes of S230, S240, S245, S250, S260, and S270 shown in FIG. 2 on items 320 in the list box shown in FIG. 6(a), items 320 in the drop-down list shown in FIG. 6(b), items 320 associated with the radio buttons shown in FIG. 6(c), items 320 associated with the check boxes shown in FIG. 6(d), and the listed items 320.

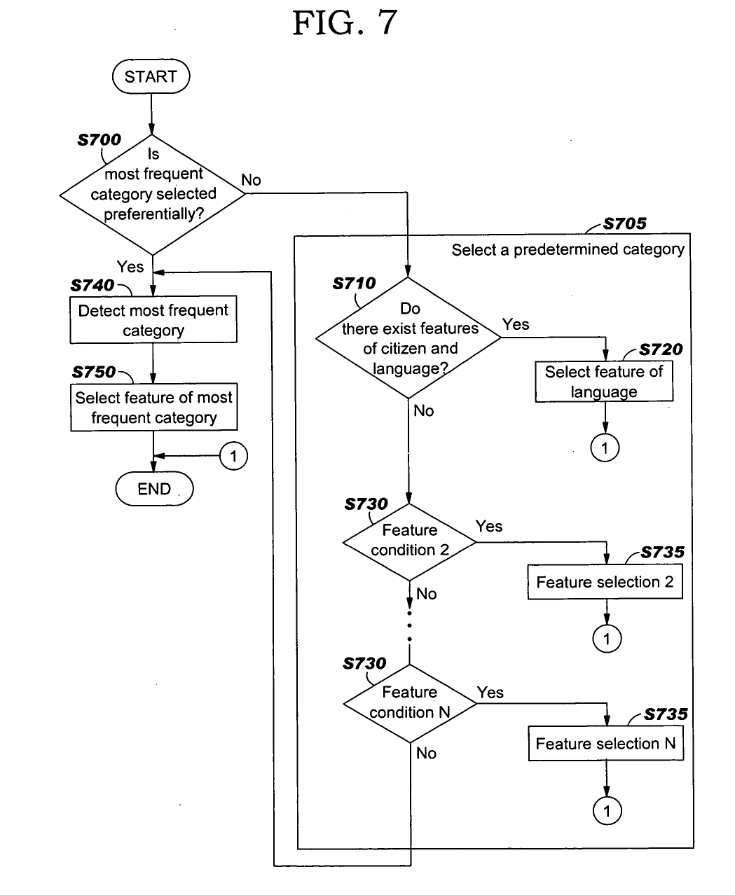

FIG. 7 shows a flow of process performed at S250 by the translation system 10 according to the embodiment. According to the flow of process, the translated expression selection unit 170 selects, for each of a plurality of items or a plurality of elements, a translated expression belonging to a predetermined category among a plurality of translated expressions corresponding to the item or element concerned.

First, the translated expression selection unit 170 determines whether the most frequent category is selected preferentially as a predetermined category to which a translated expression corresponding to each of a plurality of items or a plurality of elements should belong (S700). If the most frequent category is not selected preferentially, the translated expression selection unit 170 selects a predetermined category to which a translated expression corresponding to each of a plurality of items or a plurality of elements should belong, based on categories to which translated expressions corresponding to each of at least part of the plurality of items or the plurality of elements belong (S705). This can allow the translated expression selection unit 170 to select a predetermined category, based on the categories indicating the features characteristic of translated expressions corresponding to at least part of the plurality of items or the plurality of elements.

In selecting a predetermined category, the translated expression selection unit 170 determines whether, for each of at least part of the plurality of items or the plurality of elements, there exist a translated expression categorized as feature of citizen for a nation specified by the item or element concerned and a translated expression categorized as feature of language for the nation specified by the item or element concerned (S710).

If there exist a translated expression categorized as feature of citizen for a nation specified by the item or element concerned and a translated expression categorized as feature of language for the nation specified by the item or element concerned, the translated expression selection unit 170 selects, as a predetermined category, the feature of language for the nation specified by the item or element concerned and then selects the translated expression categorized as feature of language for the nation (S720). More specifically, if translated expressions have the feature of citizen and the feature of language for a nation, respectively, the translated expression with the feature of language for the nation is selected as that corresponding to the item or element concerned. Here, the translated expression selection unit 170 may select a translated expression with the feature of language for a nation for any of the plurality of items or the plurality of elements.

If there does not exist a translated expression categorized as feature of citizen for a nation specified by the item or element concerned nor a translated expression categorized as feature of language for the nation specified by the item or element concerned (S710), the translated expression selection unit 170 selects a translated expression corresponding to the item or element concerned, based on the category predetermined by a manufacturer or a user of the translating system 10 (S730 and S735). More specifically, if a condition established by the manufacturer or the user is met (S370), the translated expression selection unit 170 selects a translated expression with a feature established for the condition, as the translated expression corresponding to the item or element concerned (S375). Here, the translated expression selection unit 170 may select a translated expression with the feature established for the condition for any of the plurality of items or the plurality of elements.

If it is determined at S700 that the most frequent category is selected preferentially, the translated expression selection unit 170 selects the most frequent category as a predetermined category, based on categories to which translated expressions corresponding to each of the plurality of items or the plurality of elements belong.

More frequently, the most frequent category detection unit 173 in the translated expression selection unit 170 detects the most frequent category to which the most of the translated expressions corresponding to each of the plurality of items or the plurality of elements are belonging (S740). Then, the most frequent translated expression selection unit 176 in the translated expression selection unit 170 selects the most frequent category as the predetermined category and selects, for each of the plurality of items or elements, a translated expression belonging to the most frequent category among those corresponding to the item or element concerned (S750). As a result, the translation processing unit 120 uses the translated expression selected by the translated expression selection unit 170 to translate the item or element concerned.

For the above description, the translated expression selection unit 170 determines whether the most frequent category is selected preferentially, and then, based on the determination, it may select either the process of S705 or the processes of S740 and S750 or alternatively it may first perform the process of S705 and then perform the processes of S740 and S750 if no feature is selected at S720 and S735.

In addition, if any of the plurality of items or elements has a preferential feature, the translated expression selection unit 170 may select a category for this feature as the predetermined category at S705 described above. Then, the translated expression selection unit 170 may use any feature predetermined by the manufacturer or the user of the translating system 10 or any feature selected for the source document, as the preferential feature. If the translation system 10 selects a domain for the source document and uses a domain dictionary corresponding to the domain concerned for translation, the translated expression selection unit 170 may determine a preferential feature, based on the feature of an expression registered on the domain dictionary used for translation.

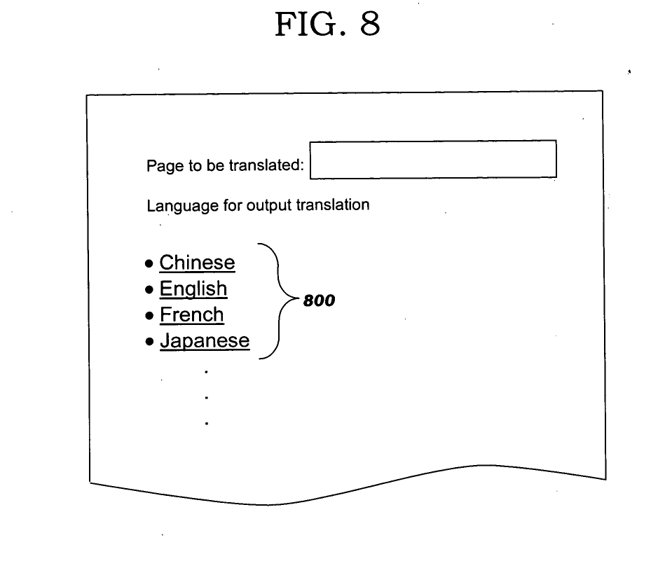

FIG. 8 shows still another example of a document to be translated by the translation system 10 according to the embodiment. This document is an example of a screen for a service provided by an application service provider to translate specified pages on the Internet. A list 800 in the document consists of a plurality of items to be used by a user to specify a language in which an output translation should be provided.

An item “Chinese” in the list 800 has a plurality of translated expressions, that is, “Chugokujin” and “Chugokugo”, corresponding thereto. Similarly, an item “French” has a plurality of translated expressions, that is, “Furansujin” and “Furansugo” and an item “Japanese” has a plurality of translated expressions, that is, “Nihonjin” and “Nihongo”, respectively. Each of the translated expressions “Chugokujin”, “Furansujin”, and “Nihonjin” is categorized as citizen for a nation specified by the corresponding item. On the other hand, each of the translated expressions “Chugokugo”, “Furansugo”, and “Nihongon” is categorized as language for the nation specified by the corresponding item.

If there exist a translated expression categorized as citizen for a nation specified by an item and another translated expression categorized as language for the nation specified by the item concerned as described above, the translated expression selection unit 170 selects the feature of language for the nation as the predetermined category at S720 and more specifically, it selects the translated expressions “Chugokugo”, “Furansugo”, and “Nihongo” for the items in the above example.

This can allow the translated expression selection unit 170 to accurately translate language selection pages which may often appear on the Internet.

For the above description, the translated expression selection unit 170 may switch between the process of selecting a translated expression categorized as citizen for a nation and the process of selecting another translated expression categorized as language for the nation, based on the type of source document. More specifically, for example, the translated expression selection unit 170 may perform a process of selecting a translated expression categorized as language for a nation if the source document is a page on the Internet and selecting another translated expression categorized as citizen for the nation if the source document is not a page on the Internet.

In addition, for example, instead of selecting a translated expression categorized as citizen for a nation or another translated expression categorized as language for the nation at S730 and S735, the translated expression selection unit 170 may select a translated expression belonging to a category selected as the predetermined category from a combination of other categories, based on a predetermined condition.

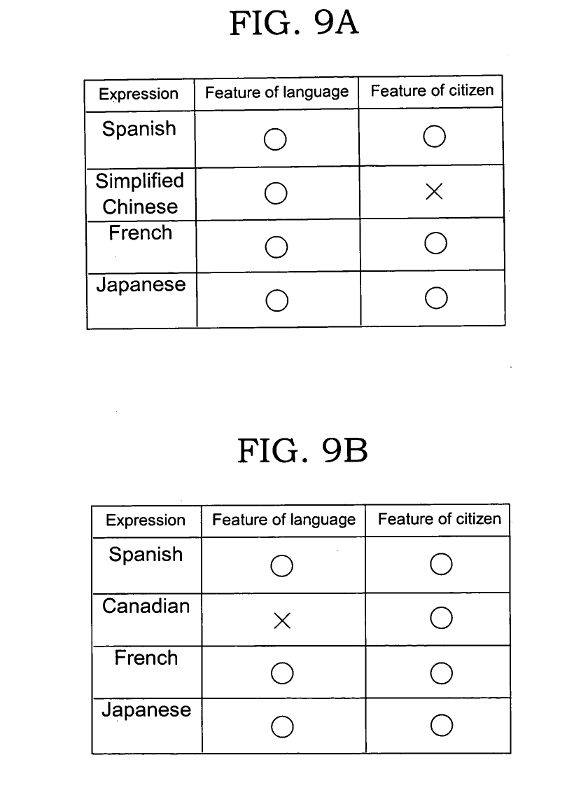

FIG. 9 shows an example of feature selection performed at S740 and S750 of FIG. 7 by the translation system 10 according to the embodiment.

FIG. 9(a) shows an example of selecting the feature of language as a result of selecting a predetermined category based on the most frequent category at S740 and S750 of FIG. 7. In this example, four items contained in a list for a specified portion include expressions “Spanish”, “Simplified Chinese”, “French”, and “Japanese” in this order. Each of the expressions “Spanish”, “Simplified Chinese”, “French”, and “Japanese” has a translated expression belonging to the category of language for a nation specified by the item concerned. In addition, each of the expressions “Spanish”, “French”, and “Japanese” has a translated expression belonging to the category of citizen for a nation specified by the item concerned.

Here, at S740 of FIG. 7, the most frequent category detection unit 173 detects the most frequent category to which the most of the translated expressions corresponding to these four items are belonging and thus selects the translated expressions belonging to the category of language for the nations specified by these items. Next, at S750 of FIG. 7, the most frequent translated expression selection unit 176 selects, for each of the four items contained in the list for the specified portion, a translated expression belonging to the most frequent category, that is, the category of language for the nation, among the plurality of translated expressions corresponding to the item concerned. As a result, the most frequent translated expression selection unit 176 generates translated expressions “Supeingo”, “Kantaiji chugokugo”, “Furansugo”, and “Nihongo” for these four items.

FIG. 9(b) shows an example of selecting the feature of citizen at S740 and S750 of FIG. 7. In this example, four items contained in a list for a specified portion include expressions “Spanish”, “Canadian”, “French”, and “Japanese” in this order. Each of the expressions “Spanish”, “Canadian”, “French”, and “Japanese” has a translated expression belonging to the category of citizen for a nation specified by the item concerned. In addition, each of the expressions “Spanish”, “French”, and “Japanese” has a translated expression belonging to the category of language for a nation specified by the item concerned.

Here, at S740 of FIG. 7, the most frequent category detection unit 173 detects the most frequent category to which the most of the translated expressions corresponding to these four items are belonging and thus selects the translated expressions belonging to the category of citizen for the nations specified by these items. Next, at S750 of FIG. 7, the most frequent translated expression selection unit 176 selects, for each of the four items contained in the list for the specified portion, a translated expression belonging to the most frequent category, that is, the category of citizen for the nation, among the plurality of translated expressions corresponding to the item concerned. As a result, the most frequent translated expression selection unit 176 generates translated expressions “Supeinjin”, “Kanadajin”, “Furansujin”, and “Nihonjin” for these four items.

As described above, use of the most frequent category detection unit 173 and the most frequent translated expression selection unit 176 can allow the translation system 10 to detect a most frequent category to which the most of translated expressions corresponding to a plurality of items in a list or a plurality of elements in a table for a specified portion belong and to use a translated expression belonging to the most frequent category for translating each of the items or elements. Thus, the translation system 10 can translate the plurality of items in the list or the plurality of elements in the table by means of one of the features for them, that is, the most frequent category to which the most of the items or elements belong, resulting in improved translation accuracy.

For the above processes, the most frequent category detection unit 173 may select and use one or more categories for a translated expression corresponding to each of the plurality of items or elements, based on the frequency of use of the translated expression. More specifically, if the item or element concerned has a plurality of translated expressions, the most frequent category detection unit 173 may use the one or more categories of one or more translated expressions which are, for example, higher than a predetermined frequency or selected in descending order in terms of frequency of use. For example, an expression “American” has a plurality of translated expressions such as “Amerika eigo” and “Amerikajin” and in general, the translated expression “Amerikajin” is used more frequently and thus, the cost for the expression “American” to be translated into “Amerika eigo” is set higher. Here, the most frequent category detection unit 173 may select only the feature of citizen for the expression “American” and cause the most frequent translated expression selection unit 176 to select that feature.

In addition, the technique of'selecting a translated expression based on the most frequent category is also effective for features other than the features of citizen and language. For example, if there exist a plurality of items “White”, “Green”, “Yellow”, and “Brown” for a specified portion, each of the plurality of items has a translated expression categorized as feature of color, while each of the three items except “Yellow” also has a translated expression categorized as feature of name. Thus, the most frequent translated expression selection unit 176 selects the translated expression categorized as feature of color for each of the items, as the most frequent category to which the most of the translated expressions corresponding to the items belong. On the contrary, if there exist a plurality of items “White”, “Green”, “Smith”, and “Brown” for a specified portion, each of the plurality of items has a translated expression categorized as feature of name, while each of the three items except “Smith” also has a translated expression categorized as feature of color. Thus, the most frequent translated expression selection unit 176 selects the translated expression categorized as feature of name for each of the items, as the most frequent category to which the most of the translated expressions corresponding to the items belong.

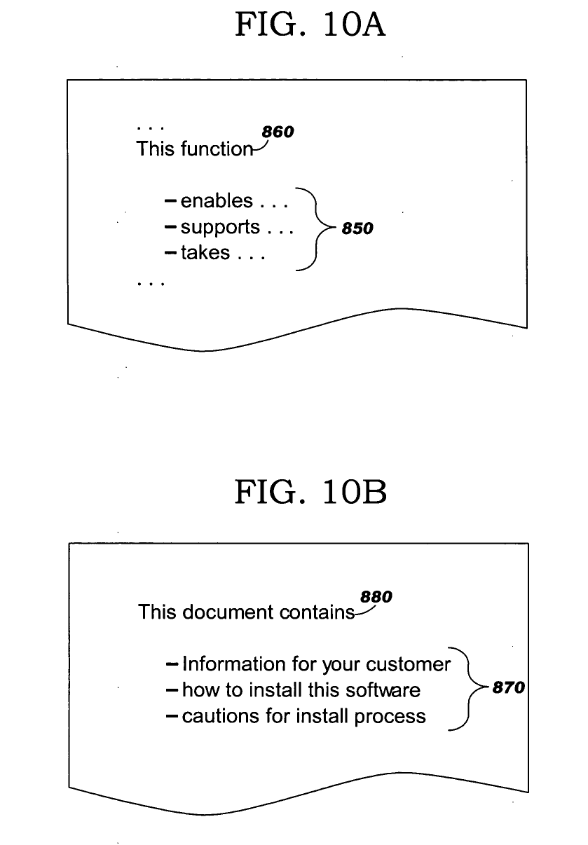

FIG. 10 shows still another example of a document to be translated by the translation system 10 according to the embodiment. The document in FIG. 10(a) includes a list 850 and a common portion 860 which indicates the subject common to the items in the list 850.

To translate the document, at S240 of FIG. 2, the common portion detection unit 180 detects whether each of the items in the list 850 such as “enables . . . ”, supports . . . ”, and “takes . . . ” is a no-subject sentence which assumes the common portion 860 described earlier than the list 850 in the document as its subject in common with the other items. More specifically, for example, if the plurality of items in the list 850 are verb phrases and the common portion described earlier than the list 850 is a noun phrase, the common portion detection unit 180 may detect that the plurality of items in the list 850 are no-subject sentences.

Then, at S270 of FIG. 2, the translation processing unit 120 translates each of the items in the list 850 as a sentence which assumes the common portion 860 as its subject. For example, the translation processing unit 120 translates the list 850 into translated expressions such as “Kono kino wa, . . . wo kano to suru_{∘}”, “Kono kino wa . . . wo sapouto suru_{∘}”, and “Kono kino wa, . . . wo toru_{∘}”. Next, the translation processing unit 120 provides an output translation of each item with the subject excluded therefrom.

The document in FIG. 10(b) includes a list 870 and a common portion 880 which has the subject and predicator common to the items in the list 870.

To translate the document, at S240 of FIG. 2, the common portion detection unit 180 detects whether or not each of the items in the list 870 such as “Information . . . ”, “how to . . . ”, and “cautions . . . ” is a sentence which assumes the common portion 880 described earlier than the list 870 in the document as its subject and predicator in common with the other items. More specifically, for example, if the plurality of items in the list 870 are objects and the common portion described earlier than the list 870 has a combination of noun and verb, the common portion detection unit 180 may detect that each of the plurality of items in the list 850 forms a sentence in combination with the common portion.

Then, at S270 of FIG. 2, the translation processing unit 120 translates each of the items in the list 870 as a sentence in combination with the common portion 880. For example, the translation processing unit 120 translates the list 870 into translated expressions such as “Kono dokyumento wa, . . . no jyoho wo fukumu_{∘}”, “Kono dokyumento wa, donoyoni shite . . . suruka wo fukumu_{∘}”, and “Kono dokyumento wa, . . . chui wo fukumu_{∘}”. Next, the translation processing unit 120 provides an output translation of each item with the common portion excluded therefrom.

As described above, when the common portion detection unit 180 detects that each of the plurality of items forms a sentence in combination with the common portion, the translation processing unit 120 translates each of the items as a sentence in combination with the common portion.

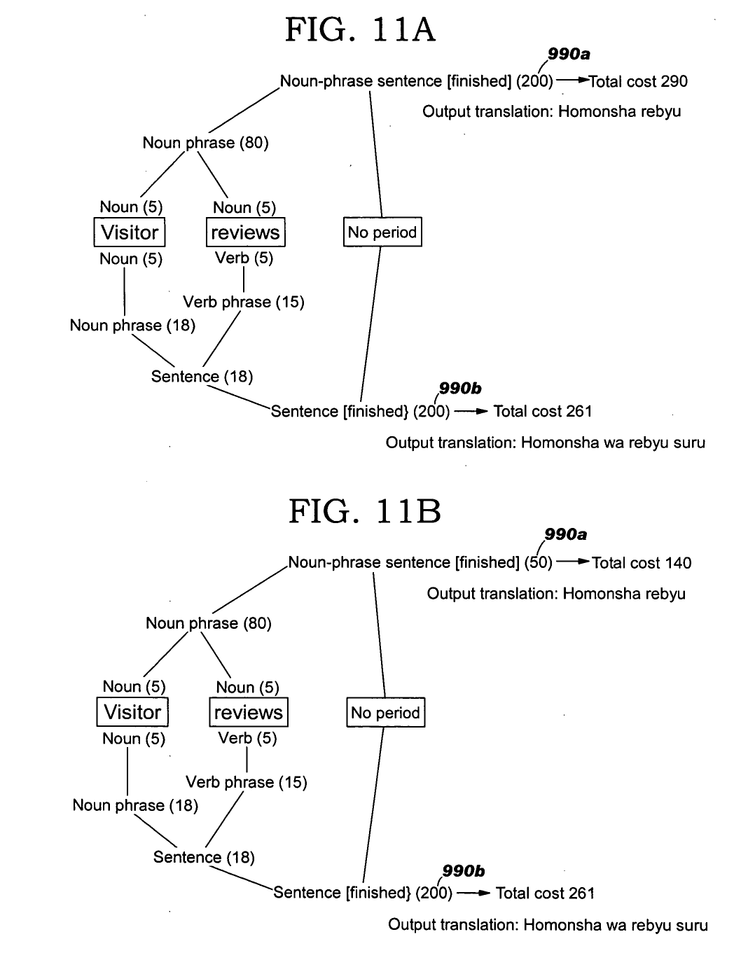

FIG. 11 shows an example of output translation provided by the translation processing unit 120 according to the embodiment when a source item or element is a noun phrase “Visitor reviews”.

FIG. 11(a) shows an output translation provided by the translation processing unit 120 when a document except a specified portion therein is to be translated in normal translation mode and sentences are to be translated preferentially.

First, the translation processing unit 120 performs a morphological analysis on the source noun phrase to parse the respective words. Next, the translation processing unit 120 performs a syntactic analysis according to the grammatical rules registered on the grammar dictionary in the translation dictionary storage unit 130.

During the syntactic analysis, the translation processing unit 120 assigns each English word a cost which indicates the frequency of use for each part of speech and the lower cost indicates the higher frequency of use. For example, the English word “Visitor” is assigned a cost of 5 when it is used as a noun, as shown in the parentheses ( ) in the figure.

Next, the translation processing unit 120 uses a combination of parts of speech described in the grammatical rules registered on the grammar dictionary in the translation dictionary storage unit 130 to generate a phrase and assigns a cost to the phrase. In the example, the portion is assigned a cost of 80 when it consists of “noun+noun”, a cost of 18 when it consists of a noun phrase consisting of a noun alone, and a cost of 15 when it consists of a verb phrase consisting of a verb alone.

Next, the translation processing unit 120 combines some phrases to generate finished sentences and then assigns a cost to each of the finished sentences. In the example, to make a sentence with “noun phrase+verb phrase” is assigned a cost of 18, and to make both a finished sentence 990a with a noun phrase alone and to make a finished sentence 990b with “noun phrase+verb phrase” are assigned a cost of 200.

Next, the translation processing unit 120 calculates a total cost for each of the finished sentences 990a and 990b as parsed above. For example, the finished sentence 990a has a total cost of 290 obtained by calculating “noun (5)+noun (5)+noun phrase (80)+finished sentence (200)”, while the finished sentence 990b has a total cost of 261.

As a result of the above syntactic analysis, the translation processing unit 120 selects, a grammatical rule which can produce the lowest total cost, that is, a grammatical rule for translating “Visitor reviews” into the finished sentence 990b, and then translates “Visitor reviews” according to the grammatical rule. Thus, the document output unit 190 provides an output translation “Homonsha wa rebyu suru”.

FIG. 11(b) shows an output translation provided by the translation processing unit 120 in a noun phrase translation mode. In a noun phrase translation mode, the translation processing unit 120 gives a higher priority to the grammatical rule for translating a specified portion as a noun phrase more preferentially in comparison with the other portions in the document. More specifically, as shown in FIG. 11(b), the cost of a finished sentence 990a consisting of a noun phrase alone is set lower than the cost of the finished sentence 990b in FIG. 11(a) by a predetermined value, for example, 150. This can allow the translation processing unit 120 to select, as the result of analyzing the syntactic, a grammatical rule for translating “Visitor reviews” into the finished sentence 990a, and then translate “Visitor reviews” according to the grammatical rule. Thus, the document output unit 190 provides an output translation “Homonsha rebyu”.

As described above, in a noun phrase translation mode, the translation processing unit 120 prefers the grammatical rule for translating a specified portion as a noun phrase more preferentially in comparison with the other portions in the document. More specifically, in a noun phrase translation mode, the translation processing unit 120 gives a higher priority to the grammatical rule for translating a specified portion as a noun phrase more preferentially in comparison with the grammatical rule for translating it into a sentence consisting of a noun and a verb.

For the above processes, the translation processing unit 120 may use the noun phrase translation dictionary 136 to translate the contents of the specified portion. The noun phrase translation dictionary 136 is a translation dictionary which stores the grammatical rules to be used for translating the specified portion as noun phrases more preferentially in comparison with the other portions.

In addition, the noun phrase translation dictionary 136 may include a translated expression dictionary which stores translated expressions to be used for translating the specified portion as noun phrases more preferentially in comparison with the other portions.

In generating a translated expression for a noun phrase extracted from the source document, the translation processing unit 120 as described above gives a higher priority to the grammatical rule to be used for translating it as a noun phrase in comparison with the other portions in the document. This can allow the translation processing unit 120 to provide a translation appropriate to the extracted noun phrase with improved translation accuracy.

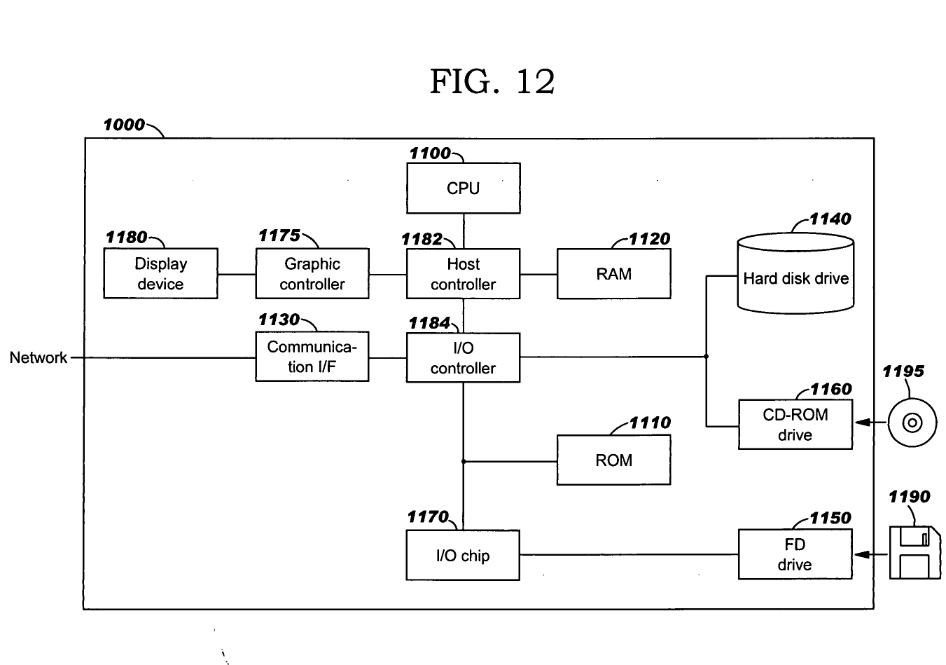

FIG. 12 shows an example of the hardware configuration of a computer 1000 according to the embodiment. The translation system 10 according to the embodiment is implemented by the computer 1000 which comprises a CPU peripherals section having a CPU 1100, a RAM 1120, a graphic controller 1175, and a display device 1180 interconnected through a host controller 1182, an input/output section having a communication interface 1130, a hard disk drive 1140, and a CD-ROM drive 1160 connected to the host controller 1182 through an input/output controller 1184, and a legacy input/output section having a ROM 1110, a flexible disk drive 1150, and an input/output chip 1170 connected to the input/output controller 1184.

The host controller 1182 connects the RAM 1120 to the CPU 1100 and the graphic controller 1175 both of which access the RAM 1120 at high transfer rates. The CPU 1100 operates under programs stored in the ROM 1110 and the RAM 1120 to control the components. The graphic controller 1175 acquires image data generated by the CPU 1100 and some other components on a frame buffer provided in the RAM 1120 and displays it on the display device 1180. Alternatively, the graphic controller 1175 may include a frame buffer for storing the image data generated by the CPU 1100 and some other components.

The input/output controller 1184 connects the host controller 1182 to the communication interface 1130, the hard disk drive 1140, and the CD-ROM drive 1160 all of which are faster input/output devices. The communication interface 1130 communicates with other devices through a network. The hard disk drive 1140 stores programs and data to be used by the computer 1000. The CD-ROM drive 1160 reads programs or data from a CD-ROM 1195 and provides them to the RAM 1120 and/or the hard disk drive 1140.

In addition, the ROM 1110 and some slower input/output devices such as the flexible disk drive 1150 and the input/output chip 1170 are also connected to the input/output controller 1184. The ROM 1110 stores a boot program executed by the computer 1000 at startup and other programs dependent on the hardware of the computer 1000. The flexible disk drive 1150 reads programs or data from a flexible disk 1190 and provides them to the CPU 1100 and/or the hard disk drive 1140 through the input/output controller 1184. The input/output chip 1170 connects various input/output devices through a flexible disk 1190 as well as, for example, a parallel port, a serial port, a keyboard port, and a mouse port.

The programs provided to the CPU 1100 through the RAM 1120 are stored in recording media such as the flexible disk 1190, the CD-ROM 1195, or an IC card and provided by the user. The programs read from the recording media are installed on the computer 1000 through the input/output controller 1184 and the RAM 1120 and then executed by the CPU 1100.

The programs installed on the computer 1000 to cause the computer 1000 to function as the translation system 10 comprise a document input module, a specified portion extraction module, a translation processing module, a translation dictionary management module, a display control information management module, a translated expression selection module including a most frequent category detection module and a most frequent translated expression selection module, a common portion detection module, and a document output module. These programs or modules cause the computer 1000 to function as the document input unit 100, the specified portion extraction unit 110, the translation processing unit 120, the translation dictionary management unit 140, the display control information management unit 160, the translated expression selection unit 170 including the most frequent category detection unit 173 and the most frequent translated expression selection unit 176, the common portion detection unit 180, and the document output unit 190, respectively. In addition, the hard disk drive 1140 or the CD-ROM 1195 may function as the translation dictionary storage unit 130 and/or the display control information storage unit 150, and alternatively, the translation dictionary 133 and the noun phrase translation dictionary 136 may be implemented as recording media on a server connected to a network.

The programs or modules described above may be stored on external storage media. In addition to the flexible disk 1190 and the CD-ROM 1195, an optical recording medium such as a DVD or PD, a magneto-optical recording medium such as an MD, a tape medium, and a semiconductor memory such as an IC card may be used as storage media. A storage device such as a hard disk or RAM provided on a server system connected to a private communication network or the Internet may be used as recording media to provide the programs to the computer 1000 through the network.

While the embodiment of the present invention has been described above, the technical scope of the present invention is not limited to the above embodiment. Various modifications and improvements can be made to the above embodiment. It should be apparent from the claims described herein that the technical scope of the present invention may encompass other embodiments with such modifications and improvements.

According to the embodiment described above, a translation system, a translation method, and a program and a recording medium for use in realizing them can be implemented as described in the clauses below.

(Clause 1) A translation system for translating a document, comprising a specified portion extraction unit for extracting specified portions of the document which are specified to be displayed in predetermined display formats; and a translation processing unit for translating contents of the specified portion in a noun phrase translation mode in which the contents are translated as noun phrases more preferentially in comparison with the other portions of the document.

(Clause 2) The translation system according to clause 1, further comprising a display control information management unit for managing display format specification information which is contained in the document for use in specifying the specified portions; wherein, if the display format specification information is detected in the document, the specified portion extraction unit extracts, as the specified portions, portions which are specified by the display format specification information to be displayed in the predetermined display formats.

(Clause 3) The translation system according to clause 2, wherein the document includes the display format specification information which is control information to be used for specifying a display method for the document and contents information which is the contents to be displayed by means of the display method specified by the display format specification information; wherein, if the display format specification information which specifies that at least part of the contents information be displayed in a list of a plurality of items is detected in the document, the specified portion extraction unit extracts, as the specified portion, a portion which is specified by the display format specification information to be displayed in a list; and wherein the translation processing unit translates, in the noun phrase translation mode, each of the plurality of items which are contained in the portion specified by the display format specification information to be displayed in a list.

(Clause 4) The translation system according to clause 3, wherein the document further includes item specification information which is the display format specification information to specify each of the plurality of items; and wherein the translation processing unit translates, in the noun phrase translation mode, each of the plurality of items which are contained in the portion specified by the display format specification information to be displayed in a list and which are specified by the item specification information.

(Clause 5) The translation system according to clause 2, wherein the translation processing unit translates items with no full stop among the plurality of items specified by the display specification information to be displayed in a list, in the noun phrase translation mode in which they are translated as noun phrases more preferentially in comparison with the other items with full stops.

(Clause 6) The translation system according to clause 2, wherein the translation processing unit translates items with no-more-than-predetermined words among the plurality of items specified by the display specification information to be displayed in a list, in the noun phrase translation mode in which they are translated as noun phrases more preferentially in comparison with the other items with more-than-predetermined words.

(Clause 7) The translation system according to clause 2, wherein the document includes the display format specification information which is control information to be used for specifying a display method for the document and contents information which is the contents to be displayed by means of the display method specified by the display format specification information; wherein, if the display format specification information which specifies that at least part of the contents information be displayed in a table with a plurality of elements is detected in the document, the specified portion extraction unit extracts, as the specified portion, a portion which is specified by the display format specification information to be displayed in the table; and wherein the translation processing unit translates, in the noun phrase translation mode, each of the plurality of elements which are contained in the portion specified by the display format specification information to be displayed in the table.

(Clause 8) The translation system according to clause 7, wherein the document further includes, as the control information, table element specification information which specifies each of the plurality of elements; and wherein the translation processing unit translates, in the noun phrase translation mode, each of the plurality of elements which are contained in the portion specified by the display format specification information to be displayed in a table and which are specified by the table element specification information.

(Clause 9) The translation system according to clause 2, wherein the display format specification information is a beginning-of-line character to be displayed at the beginning of each line in the document; and wherein, if the beginning-of-line character is detected in the document, the specified portion extraction unit extracts, as the specified portion, the contents of a line corresponding to the beginning-of-line character.

(Clause 10) The translation system according to clause 2, wherein, if the display format specification information which specifies that at least part of the document be displayed in a list of a plurality of items or in a table with a plurality of elements is detected in the document, the specified portion extraction unit extracts, as the specified portion, a portion which is specified by the display format specification information to be displayed in a list or table; wherein the translation system further comprises a translated expression selection unit which selects, for each of the plurality of items or the plurality of elements, a translated expression belonging to a predetermined category among a plurality of translated expressions corresponding to the item or element concerned; and wherein the translation processing unit uses the translated expression selected by the translated expression selection unit to translate each of the plurality of items or the plurality of elements.

(Clause 11) The translation system according to clause 10, wherein the translated expression selection unit selects, for each of at least part of the plurality of items or the plurality of elements, a translated expression categorized as citizen for a nation specified by the item or element concerned, if there exist both a translated expression categorized as citizen and a translated expression categorized as language for that nation.

(Clause 12) The translation system according to clause 10, wherein the translated expression selection unit selects the predetermined category, based on the category to which the translated expression corresponding to each of at least part of the plurality of items or the plurality of elements belongs.

(Clause 13) The translation system according to clause 12, wherein the translated expression selection unit has a most frequent category detection unit for detecting a most frequent category to which the most of translated expressions corresponding to the plurality of items or the plurality of elements belong; and a most frequent translated expression selection unit for selecting, for each of the plurality of items or the plurality of elements, a translated expression belonging to the most frequent category among a plurality of translated expressions corresponding to the item or element concerned.

(Clause 14) The translation system according to clause 1, further comprising a translation dictionary management unit for managing a noun phrase translation dictionary which stores grammatical rules to be used for translating the specified portion as noun phrases more preferentially in comparison with the other portions of the document; wherein the translation processing unit uses the noun phrase translation dictionary to translate the contents of the specified portion.

(Clause 15) A translation system for translating a document, comprising a specified portion extraction unit for extracting a specified portion which is specified by display format specification information to be displayed in a list, if the display format specification information which specifies that at least part of the document be displayed in a list of a plurality of items is detected; a common portion detection unit for detecting whether or not each of the plurality of items forms a sentence in combination with a common portion described earlier than the specified portion in the document; and a translation processing unit for translating each of the plurality of items as a sentence combined with the common portion, if it is detected that each of the plurality of items forms a sentence in combination with the common portion.

(Clause 16) The translation system according to clause 15, wherein the common portion detection unit detects whether or not each of the plurality of items assumes the common portion as its subject in common with the other items; and wherein the translation processing unit translates each of the plurality of items into a sentence with the common expression as its subject, if it is detected that each of the plurality of items assumes the common expression as its subject in common with the other items.

(Clause 17) A translation method for causing a computer to translate a document, comprising a specified portion extraction step of causing the computer to extract a specified portion of the document which is specified to be displayed in a predetermined display format; and a translation processing step of causing the computer to translate the contents of the specified portion in a noun phrase translation mode in which the contents are translated as noun phrases more preferentially in comparison with the other portions of the document.

(Clause 18) The translation method according to clause 17, further comprising a display control information management step of causing the computer to manage display format specification information which is contained in the document for use in specifying the specified portion, wherein at the specified portion extraction step, if the display format specification information is detected in the document, the computer is caused to extract, as the specified portion, a portion which is specified by the display format specification information to be displayed in the predetermined display format.

(Clause 19) The translation method according to clause 18, wherein the document includes the display format specification information which is control information to be used for specifying a display method for the document and contents information which is the contents to be displayed by means of the display method specified by the display format specification information; wherein at the specified portion extraction step, if the display format specification information which specifies that at least part of the contents information be displayed in a list of a plurality of items is detected in the document, the computer is caused to extract, as the specified portion, a portion which is specified by the display format specification information to be displayed in a list; and wherein at the translation processing step, the computer is caused to translate, in the noun phrase translation mode, each of the plurality of items which are contained in the portion specified by the display format specification information to be displayed in a list.

(Clause 20) The translation method according to clause 18, wherein the document includes the display format specification information which is control information to be used for specifying a display method for the document and contents information which is the contents to be displayed by means of the display method specified by the display format specification information; wherein at the specified portion extraction step, if the display format specification information which specifies that at least part of the contents information be displayed in a table with a plurality of-elements is detected in the document, the computer is caused to-extract, as the specified portion, a portion which is specified by the display format specification information to be displayed in the table; and wherein at the translation processing step, the computer is caused to translate, in the noun phrase translation mode, each of the plurality of elements which are contained in the portion specified by the display format specification information to be displayed in the table.

(Clause 21) The translation method according to clause 18, wherein, at the specified portion extraction step, if the display format specification information which specifies that at least part of the document be displayed in a list of a plurality of items or in a table with a plurality of elements is detected in the document, the computer is caused to extract, as the specified portion, a portion which is specified by the display format specification information to be displayed in a list or table; wherein the translation method further comprises a translated expression selection step in which the computer is caused to select, for each of the plurality of items or the plurality of elements, a translated expression belonging to a predetermined category among a plurality of translated expressions corresponding to the item or element concerned; and wherein at the translation processing step, the computer is caused to use the translated expression selected at the translated expression selection step to translate each of the plurality of items or the plurality of elements.

(Clause 22) A translation method for causing a computer to translate a document, comprising: a specified portion extraction step of causing the computer to extract a specified portion which is specified by display format specification information to be displayed in a list, if the display format specification information which specifies that at least part of the document be displayed in a list of a plurality of items is detected; a common portion detection step of causing the computer to detect whether or not each of the plurality of items forms a sentence in combination with a common portion described earlier than the specified portion in the document; and a translation processing step of causing the computer to translate each of the plurality of items as a sentence combined with the common portion, if it is detected that each of the plurality of items forms a sentence in combination with the common portion.

(Clause 23) A program for causing a computer to function as a translation system for translating a document, the program causing the computer to function as a specified portion extraction unit for extracting a specified portion of the document which is specified to be displayed in a predetermined display format; and a translation processing unit for translating contents of the specified portion in a noun phrase translation mode in which the contents are translated as noun phrases more preferentially in comparison with the other portions of the document.

(Clause 24) The program according to clause 23, further causing the computer to function as a display control information management unit for managing display format specification information which is contained in the document for use in specifying the specified portion; wherein, if the display format specification information is detected in the document, the specified portion extraction unit extracts, as the specified portion, a portion which is specified by the display format specification information to be displayed in the predetermined display format.

(Clause 25) The program according to clause 24, wherein the document includes the display format specification information which is control information to be used for specifying a display method for the document and contents information which is the contents to be displayed by means of the display method specified by the display format specification information; wherein, if the display format specification information which specifies that at least part of the contents information be displayed in a list of a plurality of items is detected in the document, the specified portion extraction unit extracts, as the specified portion, a portion which is specified by the display format specification information to be displayed in a list; and wherein the translation processing unit translates, in the noun phrase translation mode, each of the plurality of items which are contained in the portion specified by the display format specification information to be displayed in a list.

(Clause 26) The program according to clause 24, wherein the document includes the display format specification information which is control information to be used for specifying a display method for the document and contents information which is the contents to be displayed by means of the display method specified by the display format specification information; wherein, if the display format specification information which specifies that at least part of the contents information be displayed in a table with a plurality of elements is detected in the document, the specified portion extraction unit extracts, as the specified portion, a portion which is specified by the display format specification information to be displayed in the table; and wherein the translation processing unit translates, in the noun phrase translation mode, each of the plurality of elements which are contained in the portion specified by the display format specification information to be displayed in the table.

(Clause 27) The program according to clause 24, wherein, if the display format specification information which specifies that at least part of the document be displayed in a list of a plurality of items or in a table with a plurality of elements is detected in the document, the specified portion extraction unit extracts, as the specified portion, a portion which is specified by the display format specification information to be displayed in a list or table; wherein the program further causes the computer to function as a translated expression selection unit which selects, for each of the plurality of items or the plurality of elements, a translated expression belonging to a predetermined category among a plurality of translated expressions corresponding to the item or element concerned; and wherein the translation processing unit uses the translated expression selected by the translated expression selection unit to translate each of the plurality of items or the plurality of elements.

(Clause 28) A program for causing a computer to function as a translation system for translating a document, the program causing the computer to function as a specified portion extraction unit for extracting a specified portion which is specified by display format specification information to be displayed in a list, if the display format specification information which specifies that at least part of the document be displayed in a list of a plurality of items is detected; a common portion detection unit for detecting whether or not each of the plurality of items forms a sentence in combination with a common portion described earlier than the specified portion in the document; and a translation processing unit for translating each of the plurality of items as a sentence combined with the common portion, if it is detected that each of the plurality of items forms a sentence in combination with the common portion.

(Clause 29) A recording medium which records a program according to clauses 23 to 28.

### ADVANTAGES OF THE INVENTION

As is apparent from the above description, according to the present invention, a translation system, a translation method, and a program and a recording medium for use in realizing them can be provided, wherein list or table portions in a document which may be often described as noun phrases can be appropriately translated by translating it as noun phrases more preferentially in comparison with the other portions in the document, depending on a display format for the document.

What is claimed:

1) A translation system for translating a document, comprising:
a specified portion extraction unit for extracting specified portions of said document which are specified to be displayed in predetermined display formats; and
a translation processing unit for translating contents of said specified portions in a noun phrase translation mode in which the contents are translated as noun phrases more preferentially in comparison with the other portions of said document.

2) The translation system according to claim 1, further comprising:
a display control information management unit for managing display format specification information which is contained in said document for use in specifying said specified portions;
wherein, if said display format specification information is detected in said document, said specified portion extraction unit extracts, as said specified portions, portions which are specified by said display format specification information to be displayed in said predetermined display formats.

3) The translation system according to claim 2,
wherein said document includes said display format specification information which is control information to be used for specifying a display method for said document and contents information which is the contents to be displayed by means of the display method specified by said display format specification information;
wherein, if said display format specification information which specifies that at least part of said contents information be displayed in a list of a plurality of items is detected in said document, said specified portion extraction unit extracts, as said specified portion, a portion which is specified by said display format specification information to be displayed in a list; and
wherein said translation processing unit translates, in said a noun phrase translation mode, each of said plurality of items which are contained in the portion specified by said display format specification information to be displayed in a list.

4) The translation system according to claim 3,
wherein said document further includes item specification information which is said display format specification information to specify each of said plurality of items; and
wherein said translation processing unit translates, in said a noun phrase translation mode, each of said plurality of items which are contained in the portion specified by said display format specification information to be displayed in a list and which are specified by said item specification information.

5) The translation system according to claim 2,
wherein said translation processing unit translates items with no full stop among said plurality of items specified by said display specification information to be displayed in a list, in said a noun phrase translation mode in which they are translated as noun phrases more preferentially in comparison with the other items with full stops.

6) The translation system according to claim 2,
wherein said translation processing unit translates items with no-more-than-predetermined words among said plurality of items specified by said display specification information to be displayed in a list, in said a noun phrase translation mode in which they are translated as noun phrases more preferentially in comparison with the other items with more-than-predetermined words.

7) The translation system according to claim 2,
wherein said document includes said display format specification information which is control information to be used for specifying a display method for said document and contents information which is the contents to be displayed by means of the display method specified by said display format specification information;
wherein, if said display format specification information which specifies that at least part of said contents information be displayed in a table with a plurality of elements is detected in said document, said specified portion extraction unit extracts, as said specified portion, a portion which is specified by said display format specification information to be displayed in said table; and
wherein said translation processing unit translates, in said a noun phrase translation mode, each of said plurality of elements which are contained in the portion specified by said display format specification information to be displayed in said table.

8) The translation system according to claim 7,
wherein said document further includes, as said control information, table element specification information which specifies each of said plurality of elements; and
wherein said translation processing unit translates, in said a noun phrase translation mode, each of said plurality of elements which are contained in the portion specified by said display format specification information to be displayed in a table and which are specified by said table element specification information.

9) The translation system according to claim 2,
wherein said display format specification information is a beginning-of-line character to be displayed at the beginning of each line in said document; and
wherein, if said beginning-of-line character is detected in said document, said specified portion extraction unit extracts, as said specified portion, the contents of a line corresponding to said beginning-of-line character.

10) The translation system according to claim 2,
wherein, if said display format specification information which specifies that at least part of said document be displayed in a list of a plurality of items or in a table with a plurality of elements is detected in said document, said specified portion extraction unit extracts, as said specified portion, a portion which is specified by said display format specification information to be displayed in a list or table;
wherein said translation system further comprises a translated expression selection unit which selects, for each of said plurality of items or said plurality of elements, a translated expression belonging to a predetermined category among a plurality of translated expressions corresponding to said item or element concerned; and
wherein said translation processing unit uses the translated expression selected by said translated expression selection unit to translate each of said plurality of items or said plurality of elements.

11) The translation system according to claim 10,
wherein said translated expression selection unit selects, for each of at least part of said plurality of items or said plurality of elements, a translated expression categorized as citizen for a nation specified by said item or element concerned, if there exist both a translated expression categorized as citizen and a translated expression categorized as language for that nation.

12) The translation system according to claim 10,
wherein said translated expression selection unit selects said predetermined category, based on the category to which the translated expression corresponding to each of at least part of said plurality of items or said plurality of elements belongs.

13) The translation system according to claim 12,
wherein said translated expression selection unit has:
a most frequent category detection unit for detecting a most frequent category to which the most of translated expressions corresponding to said plurality of items or said plurality of elements belong; and
a most frequent translated expression selection unit for selecting, for each of said plurality of items or said plurality of elements, a translated expression belonging to said most frequent category among a plurality of translated expressions corresponding to said item or element concerned.

14) The translation system according to claim 1, further comprising:
a translation dictionary management unit for managing a noun phrase translation dictionary which stores grammatical rules to be used for translating said specified portion as noun phrases more preferentially in comparison with the other portions of said document;
wherein said translation processing unit uses said noun phrase translation dictionary to translate the contents of said specified portion.

15) A translation system for translating a document, comprising:
a specified portion extraction unit for extracting a specified portion which is specified by display format specification information to be displayed in a list, if said display format specification information which specifies that at least part of said document be displayed in a list of a plurality of items is detected;
a common portion detection unit for detecting whether or not each of said plurality of items forms a sentence in combination with a common portion described earlier than said specified portion in said document; and
a translation processing unit for translating each of said plurality of items as a sentence combined with said common portion, if it is detected that each of said plurality of items forms a sentence in combination with said common portion.

16) The translation system according to claim 15,
wherein said common portion detection unit detects whether or not each of said plurality of items assumes said common portion as its subject in common with the other items; and
wherein said translation processing unit translates each of said plurality of items into a sentence with said common expression as its subject, if it is detected that each of said plurality of items assumes said common expression as its subject in common with the other items.

17) A translation method for causing a computer to translate a document, comprising:
a specified portion extraction step of causing said computer to extract a specified portion of said document which is specified to be displayed in a predetermined display format; and
a translation processing step of causing said computer to translate contents of said specified portion in a noun phrase translation mode in which the contents are translated as noun phrases more preferentially in comparison with the other portions of said document.

18) The translation method according to claim 17, further comprising a display control information management step of causing said computer to manage display format specification information which is contained in said document for use in specifying said specified portion,
wherein at said specified portion extraction step, if said display format specification information is detected in said document, said computer is caused to extract, as said specified portion, a portion which is specified by said display format specification information to be displayed in said predetermined display format.

19) The translation method according to claim 18,
wherein said document includes said display format specification information which is control information to be used for specifying a display method for said document and contents information which is the contents to be displayed by means of the display method specified by said display format specification information;
wherein at said specified portion extraction step, if said display format specification information which specifies that at least part of said contents information be displayed in a list of a plurality of items is detected in said document, said computer is caused to extract, as said specified portion, a portion which is specified by said display format specification information to be displayed in a list; and
wherein at said translation processing step, said computer is caused to translate, in said a noun phrase translation mode, each of said plurality of items which are contained in the portion specified by said display format specification information to be displayed in a list.

20) The translation method according to claim 18,
wherein said document includes said display format specification information which is control information to be used for specifying a display method for said document and contents information which is the contents to be displayed by means of the display method specified by said display format specification information;
wherein at said specified portion extraction step, if said display format specification information which specifies that at least part of said contents information be displayed in a table with a plurality of elements is detected in said document, said computer is caused to extract, as said specified portion, a portion which is specified by said display format specification information to be displayed in said table; and
wherein at said translation processing step, said computer is caused to translate, in said a noun phrase translation mode, each of said plurality of elements which are contained in the portion specified by said display format specification information to be displayed in said table.

21) The translation method according to claim 18,
wherein, at said specified portion extraction step, if said display format specification information which specifies that at least part of said document be displayed in a list of a plurality of items or in a table with a plurality of elements is detected in said document, said computer is caused to extract, as said specified portion, a portion which is specified by said display format specification information to be displayed in a list or table;
wherein said translation method further comprises a translated expression selection step in which said computer is caused to select, for each of said plurality of items or said plurality of elements, a translated expression belonging to a predetermined category among a plurality of translated expressions corresponding to said item or element concerned; and
wherein at said translation processing step, said computer is caused to use the translated expression selected at said translated expression selection step to translate each of said plurality of items or said plurality of elements.

22) A translation method for causing a computer to translate a document, comprising:
a specified portion extraction step of causing said computer to extract a specified portion which is specified by display format specification information to be displayed in a list, if said display format specification information which specifies that at least part of said document be displayed in a list of a plurality of items is detected;
a common portion detection step of causing said computer to detect whether or not each of said plurality of items forms a sentence in combination with a common portion described earlier than said specified portion in said document; and
a translation processing step of causing said computer to translate each of said plurality of items as a sentence combined with said common portion, if it is detected that each of said plurality of items forms a sentence in combination with said common portion.

23) A program product for causing a computer to function as a translation system for translating a document, said program product causing said computer to function as:
a specified portion extraction unit for extracting a specified portion of said document which is specified to be displayed in a predetermined display format; and
a translation processing unit for translating contents of said specified portion in a noun phrase translation mode in which the contents are translated as noun phrases more preferentially in comparison with the other portions of said document.

24) The program product according to claim 23, further causing said computer to function as:
a display control information management unit for managing display format specification information which is contained in said document for use in specifying said specified portion;
wherein, if said display format specification information is detected in said document, said specified portion extraction unit extracts, as said specified portion, a portion which is specified by said display format specification information to be displayed in said predetermined display format.

25) The program product according to claim 24,
wherein said document includes said display format specification information which is control information to be used for specifying a display method for said document and contents information which is the contents to be displayed by means of the display method specified by said display format specification information;
wherein, if said display format specification information which specifies that at least part of said contents information be displayed in a list of a plurality of items is detected in said document, said specified portion extraction unit extracts, as said specified portion, a portion which is specified by said display format specification information to be displayed in a list; and
wherein said translation processing unit translates, in said a noun phrase translation mode, each of said plurality of items which are contained in the portion specified by said display format specification information to be displayed in a list.

26) The program product according to claim 24,
wherein said document includes said display format specification information which is control information to be used for specifying a display method for said document and contents information which is the contents to be displayed by means of the display method specified by said display format specification information; wherein, if said display format specification information which specifies that at least part of said contents information be displayed in a table with a plurality of elements is detected in said document, said specified portion extraction unit extracts, as said specified portion, a portion which is specified by said display format specification information to be displayed in said table; and
wherein said translation processing unit translates, in said a noun phrase translation mode, each of said plurality of elements which are contained in the portion specified by said display format specification information to be displayed in said table.

27) The program product according to claim 24,
wherein, if said display format specification information which specifies that at least part of said document be displayed in a list of a plurality of items or in a table with a plurality of elements is detected in said document, said specified portion extraction unit extracts, as said specified portion, a portion which is specified by said display format specification information to be displayed in a list or table;
wherein said program further causes said computer to function as a translated expression selection unit which selects, for each of said plurality of items or said plurality of elements, a translated expression belonging to a predetermined category among a plurality of translated expressions corresponding to said item or element concerned; and
wherein said translation processing unit uses the translated expression selected by said translated expression selection unit to translate each of said plurality of items or said plurality of elements.

28) A program product for causing a computer to function as a translation system for translating a document, said program causing said computer to function as:
a specified portion extraction unit for extracting a specified portion which is specified by display format specification information to be displayed in a list, if said display format specification information which specifies that at least part of said document be displayed in a list of a plurality of items is detected;
a common portion detection unit for detecting whether or not each of said plurality of items forms a sentence in combination with a common portion described earlier than said specified portion in said document; and
a translation processing unit for translating each of said plurality of items as a sentence combined with said common portion, if it is detected that each of said plurality of items forms a sentence in combination with said common portion.
